(19) United States
(12) Patent Application Publication
(10) Pub. No.: US 2014/0236614 A1
(43) Pub. Date: Aug. 21, 2014

(54) Financial Triage

(71) Applicant: Passport Health Communications, Inc., Franklin, TX (US)

(72) Inventors: Dustin Ryan Whittier, Nashville, TN (US); Lance Clifford Mansfield, Seattle, WA (US); Patrick Harkins, Franklin, TN (US)

(73) Assignee: Passport Health Communications, Inc., Franklin, TN (US)

(21) Appl. No.: 14/181,166

(22) Filed: Feb. 14, 2014

Related U.S. Application Data
(60) Provisional application No. 61/765,317, filed on Feb. 15, 2013.

(51) Int. Cl. G06F 19/00

(52) U.S. Cl. CPC G06F 19/322
USPC 705/2

(57) ABSTRACT

Front-end patient financial triage is provided, wherein various financial clearance checks may be processed prior to proceeding with a non-emergent patient encounter. A patient's credit history, historic payment information, and symptoms of his/her financial health, such as employment and income, family size, etc., as well as address and social security number verification may be utilized to help a health care provider determine if a patient may pay for health care services. A web-based configuration tool may be provided for allowing the health care provider to dynamically change rules that define cascading processes of a financial clearance transaction. A health care provider may be able to use this actionable financial information to make better up-front decisions about which financial category may be most appropriate for a patient. Embodiments may help to protect a health care provider's financial liability, reduce bad debt and preventable write-offs.

### CROSS-REFERENCE TO RELATED APPLICATIONS

The present application claims priority to U.S. Provisional Patent Application No. 61/765,317 titled “Financial Triage” filed Feb. 15, 2013, the disclosure of which is incorporated herein by reference in its entirety.

### BACKGROUND

Triage is a thorough up-front analysis to inspire better decision making that produces better end results. Hospitals, for example, employ educated and trained nurses and other specialists to handle the task of triage. Health care organizations oftentimes make an investment in making triage more efficient and accurate due to serious consequences that may occur because of a minor clinical mistake.

The same expectations have not been applied to a patient and payer data verification workflow (referred to herein as patient access workflow). As can be appreciated, the stakes may not be the same; however, mistakes can be costly. In an environment where performance may be measured by how many registrations a user/registrar may complete in an hour or shift, there may be ample opportunity for error and little time for manual research to help prevent errors. Oftentimes, users/registrars try to do what they can to meet a minimum financial clearance to pass a patient to a next department, leaving a majority of financial triage work to financial counselors or other employees in the back office.

Sometimes it can take thirty days or more for a hospital to begin determining whether a patient service can be written off as charity care, or whether a government-subsidized plan may cover charges. When neither a government-subsidized plan nor charity is legitimate and a patient owes a balance (which may be a full balance), it is oftentimes only partially retrieved by in-house or third party collection or may never be collected at all.

It is with respect to this and other considerations the present invention has been made.

### SUMMARY

Embodiments of the present invention provide for a front-end patient financial triage. Various financial clearance checks may be processed before proceeding with a non-emergent patient encounter. A patient's credit history, historic payment information, and symptoms of his/her financial health, such as employment and income, family size, etc., as well as address and social security number verification, may be utilized to help a health care provider determine if a patient may pay for health care services.

A health care provider may be able to use this actionable financial information to make better up-front decisions about which financial category may be most appropriate for a patient. Embodiments may help to protect a health care provider's financial liability, reduce bad debt and preventable write-offs. Additionally, unnecessary labor and costs of collection may be reduced.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF DRAWINGS

FIG. 1 is a simplified block diagram of a high-level system architecture with which embodiments of the invention may be implemented.

FIG. 2 illustrates an example of a self-pay patient financial triage process according to an embodiment.

FIG. 3 is a simplified block diagram of a computing device with which embodiments of the present invention may be practiced.

### DETAILED DESCRIPTION

Embodiments provide for front-end financial triage. Many health care organizations currently verify insurance eligibility, which may be a first step in a front-end financial triage of an insured patient. Having insurance coverage does not inherently mean that a patient may be able to pay for health care services. Some patients may not be able to pay their deductible. For example, a family of four with one working parent earning $30,000 annually may be covered by the parent's employer; however, because of the family's financial circumstances, may also qualify for charity care. Accordingly, a health care provider may bill the family's insurance company (payer) for a portion of the charges, and may write off the deductible as charity. Other patients may have wherewithal to pay, but may intentionally avoid payment.

Some patients may not be forthright about their finances. Some patients who are capable to pay may claim to need a health care provider's assistance with a high deductible. Other patients may need financial assistance, but may be reluctant to seek help. Embodiments may help to distinguish between patients who can pay and those who cannot. Credit reporting bureaus may be accessed to generate a patient's medical credit score. The score, which may be based on various factors such as employment, income, family size, debt, and payment history, may help a health care provider to determine whether a patient has the ability to pay and may provide a ranking of how likely he/she is to pay.

These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents. Referring now to the drawings, in which like numerals refer to like elements throughout the several figures, embodiments of the present invention and an exemplary operating environment will be described.

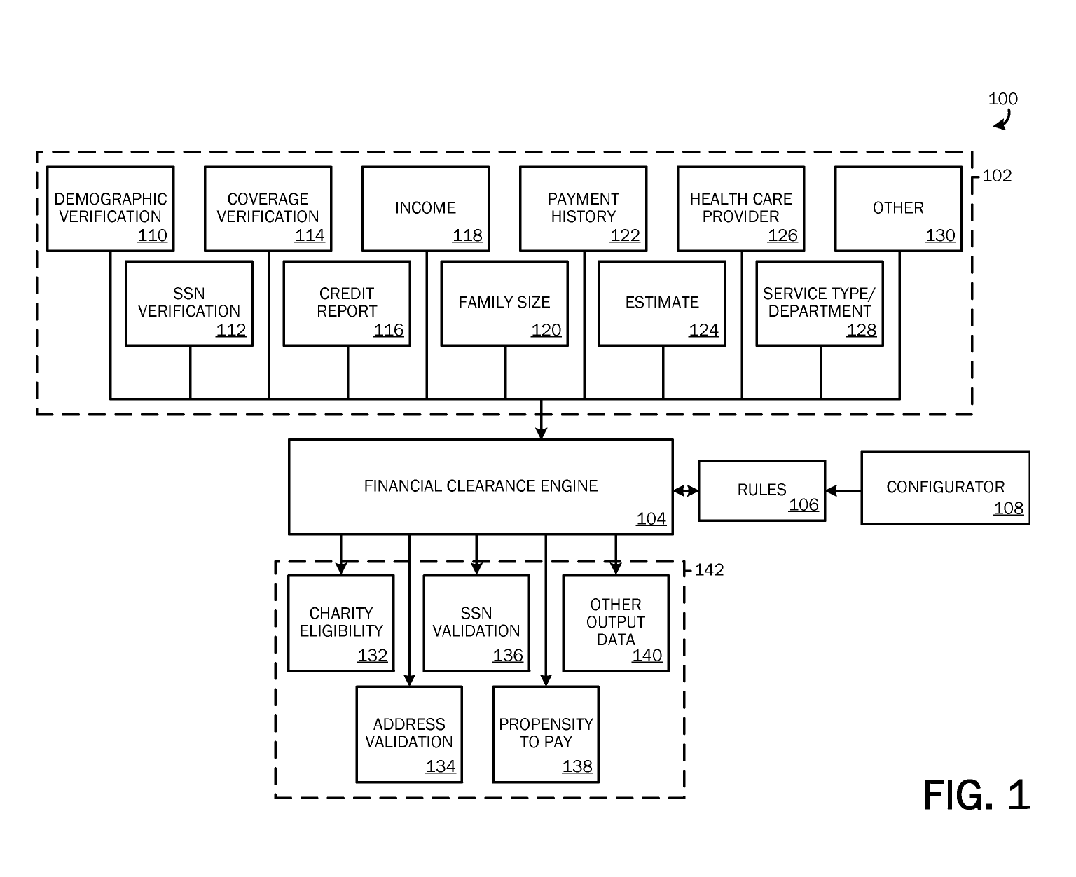

Referring now to FIG. 1, a simplified block diagram of a high-level system architecture 100 with which embodiments of the invention may be implemented is illustrated. The system 100 may include a financial clearance engine 104 operable to receive inbound information 102, run the received inbound information 102 through decision tree logic, and provide various actions and output 142 from the actions. The inbound information 102 may include one or more of demographic verification data 110, social security number verification data 112, coverage verification data 114, credit report data 116, income data 118, family size data 120, payment history data 122, estimate data 124, health care provider identification data 126, service type/department identification data 128, as well as other data 130.

According to one embodiment, a request may be sent by the financial clearance engine 104 to one or more third party data sources for one or more of demographic verification data 110, social security number verification data 112, coverage verification data 114, credit report data 116, income data 118, family size data 120, payment history data 122, estimate data 124, health care provider identification data 126, and service type/department identification data 128. Verification and/or validation processes may be performed by one or more external engines, and results of the verification and/or validation processes may be provided to the financial clearance engine 104 as inbound information 102.

According to another embodiment, a request may be sent by the financial clearance engine 104 to one or more third party data sources for one or more of demographic verification data 110, social security number verification data 112, coverage verification data 114, credit report data 116, income data 118, family size data 120, payment history data 122, estimate data 124, health care provider identification data 126, and service type/department identification data 128. Verification and/or validation processes may be performed by the financial clearance engine 104.

Requests for inbound information 102 may be sent according to a waterfall approach. For example, a first request may be sent for address verification data (demographic verification data) 110. Rules 106 may be applied to determine if the received address verification data is sufficient or if another request for additional data may need to be sent. If a determination is made that more data is needed, according to the rules 106, a next request may be sent to one or more third party data sources. For example, a next request may be sent to a credit reporting agency. Inbound information 102 from the credit reporting agency may include additional demographic verification data 110, and may also include a credit score/report 116 of a patient (or guarantor of a patient's account). The credit score/report 116 data may be utilized to determine a patient's likelihood for charity eligibility 132, and may also be utilized to assess the patient's propensity to pay 138. The eligibility for charity 132 and propensity to pay 138 may be determined utilizing one or more additional pieces of inbound information 102, for example, the patient's income 118, family size 120, payment history 122, estimate data 124, etc. According to an embodiment, a patient's federal poverty level according to federal poverty guidelines may be determined according to received inbound information 102.

According to embodiments, one or more pieces of output data 142 may be provided by the financial clearance engine 104. As mentioned above, the financial clearance engine 104 may be operable to determine a patient's likelihood for charity eligibility 132, and may also be utilized to assess the patient's propensity to pay 138. Additional output data 142 may include address validation 134, social security number validation 136, and may include other output data 140.

Output data 142 may be provided in various ways. For example, output data 142 may be displayed in real time in HTML on a web-based page, may be sent to a requesting party via a batch file, may be posted electronically to a hospital information system (HIS), etc. The output data 142 may include a notification of missing or inconsistent data, may include a response to charity eligibility 132, and may include a medical credit score and a confidence level. The score may be provided on a scale. For example, on a scale of 1 to 10, a given patient's ability to pay may be determined to be a 6. The response to charity eligibility 132 may be provided by a simple yes or no answer, or may also include what types of charities for which a patient may be eligible. If a patient is eligible for government-subsidized coverage, the response to charity eligibility 132 may also include this information. According to an embodiment, the output data 142 may also include recommendation information. For example, if a determination is made that a patient is able to pay for an upcoming health care encounter, but has a history of non-payment for health care bills, a recommendation to collect payment up-front may be provided.

According to embodiments, the system 100 may include a configurator 108 operable to allow a user to dynamically change the financial clearance engine rules 106. The configurator 108 may be a web-based tool for modifying one or more rules 106. The one or more rules 106 may define the decision tree and may define what pieces of inbound data 102 to request depending on certain predefined circumstances. The rules 106 may be utilized to determine the quantum of information to process. For example, the rules 106 may define the parameters used to determine what transactions to run, including patient type (e.g., commercial payer, government-subsidized payer, self-pay, etc.), amount owed by a patient, where services are being rendered (e.g., health care provider 126), in what department 128 or a service type being provided (e.g., emergency department, scheduling, inpatient surgery, outpatient surgery, etc.). The rules 106 may determine how to cascade processes of a financial clearance transaction, which may drive hierarchy of the process, for example, whether a financial clearance transaction may need to include coverage discovery (e.g., coverage verification 114) as part of the process. As another example, if a patient owes a minimal amount (e.g., $10), certain transactions/processes may not be performed because the cost to perform the transactions/processes may outweigh the amount due to the provider.

As described above, coverage verification data 114 may be one piece of inbound information 102. A self-pay patient may be assessed for qualification for a government-subsidized payer program (e.g., Medicaid). Oftentimes, patients who qualify for government-subsidized coverage seek treatment as self-pay because they are not aware of their own eligibility. Verifying government eligibility and beginning the enrollment process during pre-registration or registration may help to provide excellent customer service. It may be beneficial to both the patient and the health care provider because it may help to secure reimbursement for the health care provider and help to ease personal financial burden for the patient.

Sometimes, a patient may earn too much money to qualify for government-subsidized coverage, but may not earn enough to pay for a needed surgery. Patients who fall into this category may be eligible for some level of charity care. Rules 106 may define charity care levels for screening patients against the health care provider's guidelines.

Patients with too much income to qualify for government-subsidized coverage or charity care may be expected to make payment prior to a health care encounter. If a patient resists, the medical credit score determined by the financial clearance engine 104 may help a registrar/user to respond accordingly. By running a score, more current, accurate, and detailed information than what the patient may be willing to divulge may be provided. With an understanding of a patient's ability and propensity to pay 138, a health care provider may be able to proceed with more confidence and offer any approved discounts or payment plan options to encourage payment.

Historically, it has not been practical to address financial triage tasks while a patient is on-site, and has become a task for health care provider financial counselors to gather the necessary information from patients to determine eligibility. Because financial triage tasks may require heavy paperwork, research, and follow-up, it has rarely been completed pre-service and may often be delayed for weeks or longer. Embodiments of the present invention automate the decision tree and may identify a correct classification for a patient in real time. Features for converting paperwork to electronic formats may be included, further automating and accelerating the process.

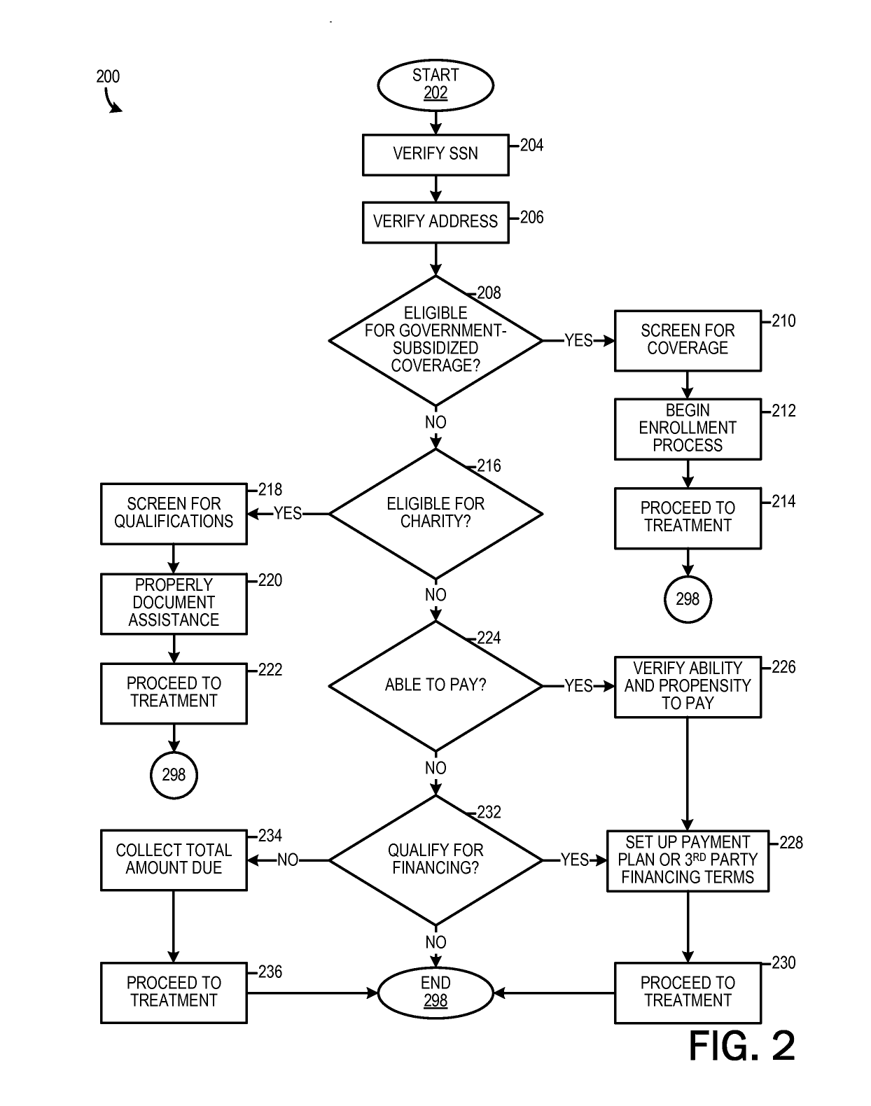

FIG. 2 illustrates an example of a self-pay patient financial triage process 200 according to an embodiment. The process 200 may start at OPERATION 202 and proceed to OPERATION 204, where a patient's social security verification data 112 may be input, and a verification that the patient's social security number matches the patient's name may be performed. The process 200 may then proceed to OPERATION 206, where a verification of the patient's address may be performed. According to embodiments, address validation 136 may comprise a verification that an address is a deliverable address and also a verification that a patient lives or has lived at the address.

The process 200 may proceed to DECISION OPERATION 208, where a determination may be made as to whether a patient is eligible for government-subsidized coverage. Eligibility for government-subsidized coverage may be determined utilizing one or more pieces of inbound information 102, such as demographic verification data 110, income data 118, family size data 120, etc. If a determination is made that a patient is eligible for government-subsidized coverage, the patient may be screened for other coverages at OPERATION 210. An enrollment process for government-subsidized coverage may be launched at OPERATION 212, and at OPERATION 214, the patient's account may be cleared (for the financial triage process) to allow the patient to proceed to receive treatment. The process may end at OPERATION 298.

If the patient does not qualify for government-subsidized coverage at OPERATION 208, determining if a patient is eligible for charity may be performed at DECISION OPERATION 216. Eligibility for charity may be determined utilizing various pieces of inbound information 102 such as demographic verification data 110, coverage verification data 114, credit report data 116, income data 118, family size data 120, estimate data 124, health care provider data 126, service type/department data 128, etc. Using inbound information 102, the patient may be screened for qualifications for one or more charities at OPERATION 218. If the patient qualifies for charity care, documentation of qualification may be performed at OPERATION 220, and at OPERATION 222, the patient's account may be cleared (for the financial triage process) to allow the patient to proceed to receive treatment. The process may end at OPERATION 298.

If the patient does not qualify for charity, determining the patient's ability to pay may be performed at DECISION OPERATION 224. Determining a patient's ability to pay may include both verifying the patient's ability and propensity to pay (OPERATION 226). This determination may be made utilizing various pieces of inbound information 102 such as demographic verification data 110, coverage verification data 114, credit report data 116, income data 118, family size data 120, payment history data 122, estimate data 124, health care provider data 126, service type/department data 128, etc. If a determination is made that the patient is able to pay and is likely to pay, a payment plan or third party financing terms may be set up at OPERATION 228. At OPERATION 230, the patient's account may be cleared (for the financial triage process) to allow the patient to proceed to receive treatment.

If a determination is made that the patient is not able to pay and/or does not have a propensity to pay, the process 200 may proceed to DECISION OPERATION 232, where a determination is made as to whether the patient qualifies for financing. If the patient does not qualify for financing (e.g., the patient's propensity to pay 138 is determined to be below a predetermined threshold), payment for health care services may be required (prior to services being rendered) at OPERATION 234. Once payment is received, at OPERATION 236, the patient's account may be cleared (for the financial triage process) to allow the patient to proceed to receive treatment. The process may end at OPERATION 298.

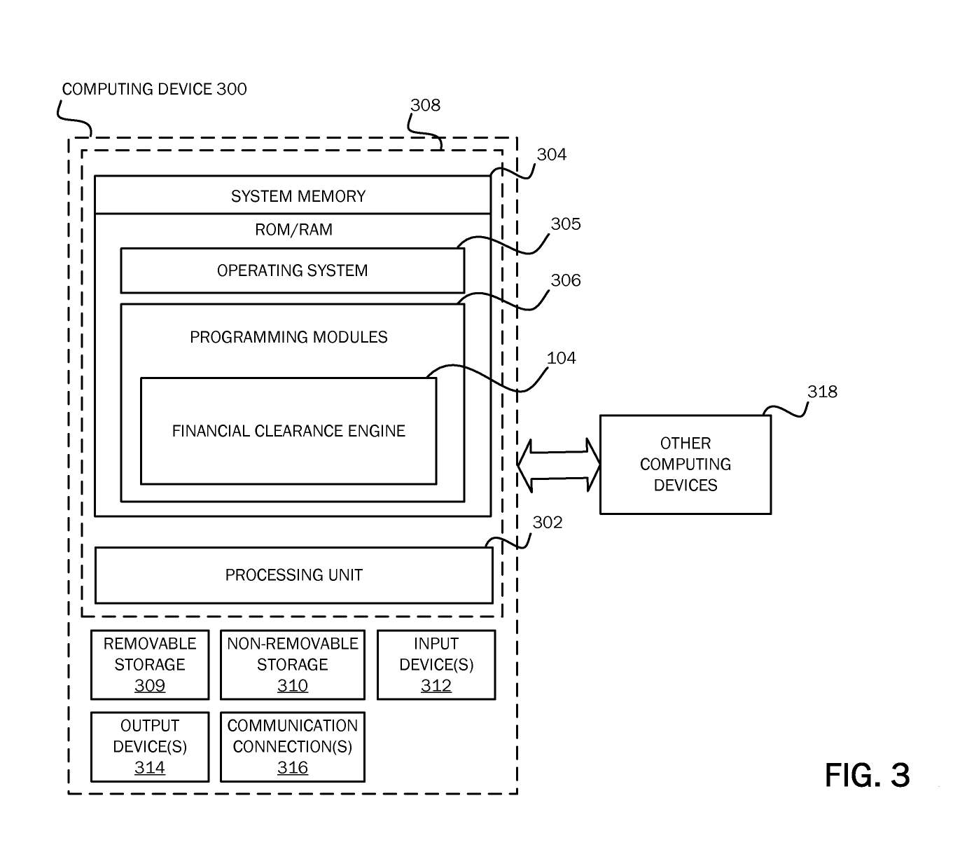

As described above, embodiments of the invention may be implemented via local and remote computing and data storage systems. Such memory storage and processing units may be implemented in a computing device, such as computing device 300 of FIG. 3. Any suitable combination of hardware, software, or firmware may be used to implement the memory storage and processing unit 302. For example, the memory storage and processing unit may be implemented with computing device 300 or any other computing devices 318, in combination with computing device 300, wherein functionality may be brought together over a network in a distributed computing environment, for example, an intranet or the Internet, to perform the functions as described herein. Such systems, devices, and processors (as described herein) are examples and other systems, devices, and processors may comprise the aforementioned memory storage and processing unit, consistent with embodiments of the invention.

With reference to FIG. 3, a system consistent with embodiments of the invention may include one or more computing devices, such as computing device 300. The computing device 300 may include at least one processing unit 302 and a system memory 304. The system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include the financial clearance engine 104, wherein financial clearance engine 104 is a software application having sufficient computer-executable instructions, which when executed, performs functionalities as described herein. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308.

Although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

The computing device 300 may also have one or more input device(s) 312 such as a keyboard, a mouse, a pen, a sound input device, a touch input device, etc. The output device(s) 314 such as a display, speakers, a printer, etc. may also be included. The aforementioned devices are examples and others may be used. The computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

Program modules, such as the financial clearance engine 104, may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable user electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture (computer readable media). The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system.

Embodiments of the present invention, for example, are described above with reference to block diagrams and/or operational illustrations of methods, systems, and computer program products according to embodiments of the invention. For example, FIG. 1-3 and the described functions taking place with respect to each illustration may be considered steps in a process routine performed by one or more local or distributed computing systems. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing front-end financial triage, the method comprising:
receiving inbound information;
applying a first rule of a set of rules to the received inbound information; and
determining one or more financial triage tasks to perform.

2. The method of claim 1, further comprising:
sending a request to perform a financial triage task of the one or more determined financial triage tasks;
receiving a response;
applying a next rule of the set of rules to the received response; and
determining another one or more financial triage tasks to perform.

3. The method of claim 1, wherein determining one or more financial triage tasks to perform comprises determining whether to perform one or more of:
social security number validation;
address validation;
government-subsidized coverage eligibility;
charity eligibility;
propensity to pay analysis; or financing eligibility.

4. The method of claim 3, wherein performing address validation comprises verifying that an address is a deliverable address and verifying that a patient lives or has lived at the address.

5. The method of claim 1, further comprising receiving a modification to one or more rules of the set of rules.

6. The method of claim 5, wherein receiving a modification to one or more rules of the set of rules comprises providing a web-based interface and receiving a modification to a rule via the web-based interface.

7. The method of claim 1, wherein receiving inbound information comprises receiving one or more of:
demographic verification data;
social security verification data;
coverage verification data;
credit report data;
income data;
family size data;
payment history data;
healthcare service estimate data;
healthcare provider data; or
healthcare service type data.

8. A system for providing front-end financial triage,
one or more processors; and
a memory coupled to the one or more processors, the one or more processors operable to:
receive inbound information;
apply a first rule of a set of rules to the received inbound information;
and
determine one or more financial triage tasks to perform.

9. The system of claim 8, further comprising a configurator, the configurator operable to allow a user to dynamically change one or more rules of the set of rules.

10. The system of claim 9, wherein the configurator is a web-based tool.

11. The system of claim 9, wherein the one or more processors are further operable to receive a change one or more rules of the set of rules.

12. The system of claim 8, wherein the one or more processors are further operable to:
send a request to perform a financial triage task of the one or more determined financial triage tasks;
receive a response;
apply a next rule of the set of rules to the received response; and
determine another one or more financial triage tasks to perform.

13. The system of claim 8, wherein in determining one or more financial triage tasks to perform, the one or more processors are operable to determine whether to perform one or more of:
social security number validation;
address validation;
government-subsidized coverage eligibility;
charity eligibility;
propensity to pay analysis; or
financing eligibility.

14. The system of claim 8, wherein in receiving inbound information, the one or more processors are operable to receive on one or more of:
demographic verification data;
social security verification data;
coverage verification data;
credit report data;
income data;
family size data;
payment history data;
healthcare service estimate data;
healthcare provider data; or
healthcare service type data.

15. A computer-readable medium containing computer executable instructions which, when executed by a computer, perform a method for providing front-end financial triage, the method comprising:
receiving inbound information;
applying a first rule of a set of rules to the received inbound information; and
determining one or more financial triage tasks to perform, the one or more financial triage tasks comprising one or more of:
social security number validation;
address validation;
government-subsidized coverage eligibility;
charity eligibility;
propensity to pay analysis; or
financing eligibility.

16. The computer-readable medium of claim 15, further comprising:
sending a request to perform a financial triage task of the one or more determined financial triage tasks;
receiving a response;
applying a next rule of the set of rules to the received response; and
determining another one or more financial triage tasks to perform.

17. The computer-readable medium of claim 15, wherein performing address validation comprises verifying that an address is a deliverable address and verifying that a patient lives or has lived at the address.

18. The computer-readable medium of claim 15, further comprising receiving a modification to one or more rules of the set of rules.

19. The computer-readable medium of claim 18, wherein receiving a modification to one or more rules of the set of rules comprises providing a web-based interface and receiving a modification to a rule via the web-based interface.

20. The computer-readable medium of claim 15, wherein receiving inbound information comprises receiving one or more of:
demographic verification data;
social security verification data;
coverage verification data;
credit report data;
income data;
family size data;
payment history data;
healthcare service estimate data;
healthcare provider data; or
healthcare service type data.
